(19) United States
(12) Patent Application Publication
(10) Pub. No.: US 2024/0110569 A1
(43) Pub. Date: Apr. 4, 2024

(54) SAFETY DISCONNECT SWITCH USED WITH ELECTRICAL SUBMERSIBLE PUMPS

(71) Applicants: Robert Hicks, Oklahoma City, OK (US); Joshua Prather, Millsap, TX (US); Lucas Beckner, Drumright, OK (US); Brent Storts, Blanchard, OK (US)

(72) Inventors: Robert Hicks, Oklahoma City, OK (US); Joshua Prather, Millsap, TX (US); Lucas Beckner, Drumright, OK (US); Brent Storts, Blanchard, OK (US)

(21) Appl. No.: 18/375,834

(22) Filed: Oct. 2, 2023

Related U.S. Application Data
(60) Provisional application No. 63/411,968, filed on Sep. 30, 2022.

(51) Int. Cl. F04D 15/00; F04D 13/08

(52) U.S. Cl. CPC F04D 15/0077; F04D 13/086; H01H 71/10

(57) ABSTRACT

A pumping system including a safety disconnect switch. The pumping system includes a variable frequency drive, an electrical submersible pump, and a motor connected to the electrical submersible pump. The pumping system also includes a safety disconnect switch disposed downstream from the variable frequency drive and upstream from the electrical submersible pump to prevent electric power generated by the motor from traveling upstream from the safety disconnect switch in the pumping system. A method of preventing electric power from flowing upstream from a safety disconnect switch in a pumping system includes the step of opening a circuit in the safety disconnect switch to prevent electric power from a motor attached to an electrical submersible pump from flowing upstream from the safety disconnect switch to other components of the pumping system.

### CROSS-REFERENCE TO RELATED APPLICATIONS

The present application is a conversion of U.S. Provisional Application No. 63/411,968, filed Sep. 30, 2022, which claims the benefit under 35 U.S.C. 119(e). The disclosures of which are hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a safety disconnect switch to be used in a pumping system for an electric submersible pump (ESP).

### 2. Description of the Related Art

In an oil and gas well, the future of electrical submersible pumping is to utilize a permanent magnet motor. The typical electrical submersible pump (ESP) installation consists of a downhole gauge to monitor pressure and temperature, connected to a motor that drives a single or double seal, also known as a protector. The single or double seal inhibits oil ingress into the motor while permitting pressure equalization between the well annulus and motor. The motor is connected to a downhole pump and is typically a centrifugal pump.

Historically, the motor has been a 2 Pole Induction motor, which is now being replaced by a permanent magnet motor. Permanent magnet motors are new to the oil and gas industry and offer several benefits including a higher efficiency, a power factor, and increased reliability. The foundation of a permanent magnet motor is that it utilizes rare earth magnets in the rotor to enable better synchronization with the electrical current flowing through the stator thereby increasing the efficiency and power factor. One of the pitfalls with permanent magnet motors is that during pump installation/maintenance/removal, the wellbore equalizes pressure through the pump which causes rotation of the pump and subsequently the motor. When the motor spins, the magnets within the rotor spin thereby generating power which is transmitted up the cable to the surface. This presents a safety issue whereby the technicians stand to get electrocuted if they are unaware the pumping system is spinning downhole. There are ways to prevent rotation during installation and removal of the pumping system.

Accordingly, there is a need for a device that does not prevent rotation, but can still protect the technician on the surface from being accidentally exposed to lethal voltage while they are working on the pumping system.

### SUMMARY OF THE DISCLOSURE

The present disclosure is directed to a pumping system including a safety disconnect switch. The pumping system includes a variable frequency drive, an electrical submersible pump, and a motor connected to the electrical submersible pump. The pumping system also includes a safety disconnect switch disposed downstream from the variable frequency drive and upstream from the electrical submersible pump to prevent electric power generated by the motor from traveling upstream from the safety disconnect switch in the pumping system.

The present disclosure is also directed to a method of preventing electric power from flowing upstream from a safety disconnect switch in a pumping system. The method includes the step of opening a circuit in the safety disconnect switch to prevent electric power from a motor attached to an electrical submersible pump from flowing upstream from the safety disconnect switch to other components of the pumping system.

### BRIEF DESCRIPTION OF THE DRAWINGS

FIG. 1 is a schematic view of a pumping system incorporating a safety disconnect switch constructed in accordance with the present disclosure.

FIG. 2A is a perspective view of a housing enclosing the safety disconnect switch of the pumping system constructed in accordance with the present disclosure.

FIG. 2B is a perspective view of the safety disconnect switch in the housing.

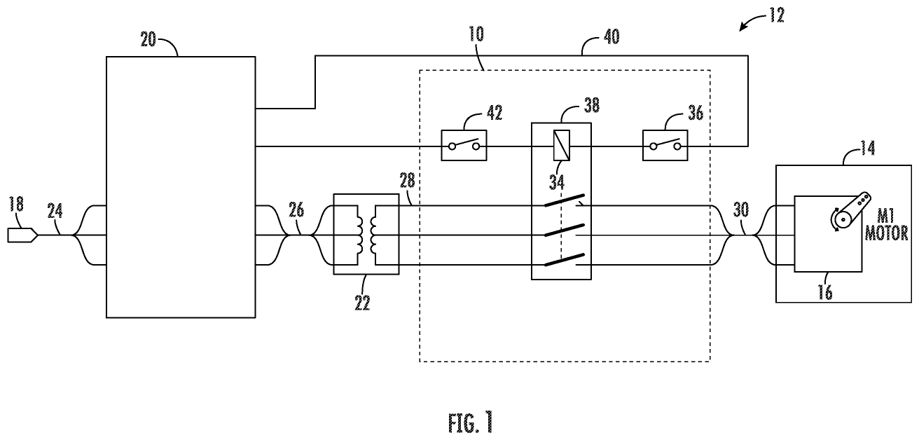

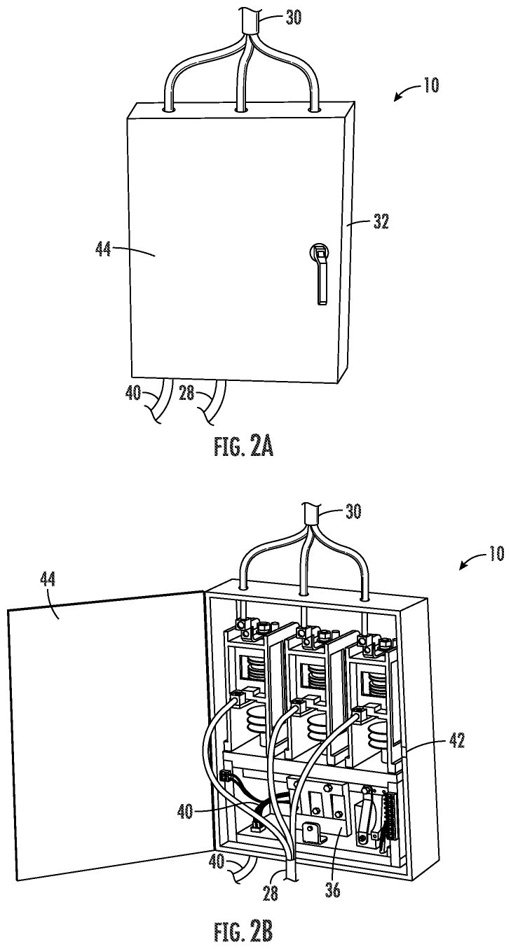

### DETAILED DESCRIPTION OF THE DISCLOSURE

The present disclosure relates to a safety disconnect switch 10 for use with a pumping system 12 using an electrical submersible pump (ESP) 14 that is connected to a permanent magnet motor 16. The safety disconnect switch 10 is used to prevent power generated by the permanent magnet motor 16 downhole in a well from harming a person working on the pumping system 12 when power has been turned off for installation, maintenance or removal of the ESP 14 and connected motor 16. In addition to the safety disconnect switch 10, the ESP 14 and the connected permanent magnet motor 16, the pumping system 12 can include the following: (1) a power supply 18 that provides power to the pumping system 12, (2) a variable frequency drive (VFD) 20 to vary the frequency/speed of the power supplied to the pumping system 12, and (3) a step up transformer 22 to transform a low voltage and high current received from the VFD 20 to a high voltage and low current to send to the motor 16 and ESP 14.

The layout of the pumping system 12 can be varied, but in this exemplary embodiment, a first power line/cable 24 can carry power from the power supply 18 to the VFD 20. A second power line/cable 26 can carry the low voltage and high current power from the VFD 20 to the step up transformer 22. A third power line/cable 28 can transmit the high voltage and low current power from the step up transformer 22 to the safety disconnect switch 10. A fourth power line/cable 30 can transmit the power from safety disconnect switch 10 to the ESP 14 and motor 16. It is contemplated that the safety disconnect switch 10 can be positioned anywhere in the pumping system 12 upstream from the ESP 14 and downstream from the VFD 20.

More specifically, the safety disconnect switch 10 is used to control the electrical connection, or electrical circuit, of the third and fourth power lines/cables 28 and 30. The safety disconnect switch 10 can include a housing 32 for containment of the components of the safety disconnect switch 10, a contactor 34 for facilitating the switching on and off of the electrical connection of the third and fourth power lines/cables 28 and 30, and a primary switch 36 for controlling when the circuit 38 controlled by the contactor 34 is open or closed.

The primary switch 36 can be set up to be a manual switch or an automated switch that is tied to operation of the VFD 20. If the primary switch 36 is a manual switch, a user/operator can move the switch 36 in one direction and the primary switch 36 and the circuit 38 controlled by the contactor 34 is open and power from the ESP 14 cannot travel to the step up transformer 22 or the VFD 20. Conversely, if the user/operator moves the manual primary switch 36 in the other direction, the primary switch 36 is closed and the circuit 38 controlled by the contactor 34 is closed and power will be permitted to flow downstream in the pumping system 12 from the safety disconnect switch 10.

If the primary switch 36 is an automatic switch that is tied to the VFD 20, the primary switch 36 is closed when the primary switch 36 receives power from the VFD 20 via a primary switch power line 40. When the primary switch 36 is closed, the circuit 38 controlled by the contactor 34 is closed to permit power to flow downstream from the safety disconnect switch 10 to the ESP 14. When the primary switch 36 does not receive power from the VFD 20, via the primary switch power line 40, the primary switch 36 defaults to an open position. When the primary switch 36 is in the open position, the circuit 38 controlled by the contactor 34 is in the open position, which prevents power from being able to pass from the ESP 14 to any components of the pumping system 12 upstream from the safety disconnect switch 10. One example of when the primary switch 36 would not receive power from the VFD 20 via the primary switch power line 40 is when power is turned off for the pumping system 12 from the power supply 18 for maintenance of the pumping system 12.

In another embodiment, the safety disconnect switch 10 can include a door switch 42 that will open when a door 44 to the housing 32 of the safety disconnect switch 10 is opened. When the door switch 42 is open, this causes the circuit 38 controlled by the contactor 34 to open and power is not permitted to pass upstream in the pumping system 12 from the safety disconnect switch 10. When the door 44 to the housing 32 of the safety disconnect switch 10 is closed, the door switch 42 will close, which causes the circuit 38 controlled by the contactor 34 to close. This permits power to flow through the safety disconnect switch 10 and to the ESP 14.

The present disclosure is also directed to a method of cutting or preventing power from the ESP 14 and connected motor 16 from flowing into components of a pumping system 12 that are disposed upstream from the safety disconnect switch 10.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A pumping system including a safety disconnect switch, the pumping system comprising:
a variable frequency drive;
an electrical submersible pump;
a motor connected to the electrical submersible pump; and
a safety disconnect switch disposed downstream from the variable frequency drive and upstream from the electrical submersible pump to prevent electric power generated by the motor from traveling upstream from the safety disconnect switch in the pumping system.

2. The pumping system of claim 1 further comprising a step up transformer disposed between the variable frequency drive and the safety disconnect switch.

3. The pumping system of claim 1 further comprising a power supply to provide electrical power to the pumping system.

4. The pumping system of claim 1 further comprising a first power line between the variable frequency drive and the safety disconnect switch to deliver power to the electrical submersible pump and the motor and a second power line between the variable frequency drive and the safety disconnect switch to determine if power is being supplied from the variable frequency drive.

5. The pumping system of claim 4 wherein the safety disconnect switch shuts off power through the safety disconnect switch to the electrical submersible pump and the motor if the safety disconnect switch does not detect power from the second power line.

6. The pumping system of claim 4 wherein the safety disconnect switch includes a contactor for facilitating switching power flowing through the safety disconnect switch and to the electrical submersible pump and the motor on and off.

7. The pumping system of claim 4 wherein the safety disconnect switch includes a primary switch connected to the second power line for controlling when a circuit controlled by the contactor is open or closed.

8. The pumping system of claim 7 wherein the primary switch opens the circuit controlled by the contactor when power is not detected from the second power line.

9. The pumping system of claim 7 wherein the safety disconnect switch is disposed in a housing with a door hingedly attached thereto, the safety disconnect switch includes a door switch wherein the circuit is open and power is not permitted to flow through the safety disconnect switch when the door switch detects that the door is an open position.

10. A method of preventing electric power from flowing upstream from a safety disconnect switch in a pumping system, the method comprising:
opening a circuit in the safety disconnect switch to prevent electric power from a motor attached to an electrical submersible pump from flowing upstream from the safety disconnect switch to other components of the pumping system.

11. The method of claim 10 wherein the pumping system further comprises a variable frequency drive disposed upstream from the safety disconnect switch.

12. The method of claim 11 wherein the pumping system further comprises a step up transformer disposed between the variable frequency drive and the safety disconnect switch.

13. The method of claim 12 wherein the pumping system further comprises a power supply to provide electrical power to the pumping system.

14. The method of claim 11 wherein the pumping system further comprises a first power line between the variable frequency drive and the safety disconnect switch to deliver power to the electrical submersible pump and the motor and a second power line between the variable frequency drive and the safety disconnect switch to determine if power is being supplied from the variable frequency drive.

15. The method of claim 14 wherein the safety disconnect switch shuts off power through the safety disconnect switch to the electrical submersible pump and the motor if the safety disconnect switch does not detect power from the second power line.

16. The method of claim 14 wherein the safety disconnect switch includes a contactor for facilitating switching power flowing through the safety disconnect switch and to the electrical submersible pump and the motor on and off.

17. The method of claim 14 wherein the safety disconnect switch includes a primary switch connected to the second power line for controlling when a circuit controlled by the contactor is open or closed.

18. The method of claim 17 wherein the primary switch opens the circuit controlled by the contactor when power is not detected from the second power line.

19. The method of claim 17 wherein the safety disconnect switch is disposed in a housing with a door hingedly attached thereto, the safety disconnect switch includes a door switch wherein the circuit is open and power is not permitted to flow through the safety disconnect switch when the door switch detects that the door is an open position.
